(19) United States
(12) Patent Application Publication
(10) Pub. No.: US 2016/0244624 A1
(43) Pub. Date: Aug. 25, 2016

(54) Coating Removal from Biaxially-Oriented Polypropylene Films for Food Packaging

(71) Applicant: Geo-Tech Polymers, LLC, Westerville, OH (US)

(72) Inventors: Anne B. McCoppin, Powell, OH (US); John S. Essman, Wheelersburg, OH (US); Larry M. Miller, South Wester, OH (US); Chad C. Smith, Waverly, OH (US); Ronald L. Whaley, Portsmouth, OH (US); Gordon D. Jones, Circleville, OH (US)

(21) Appl. No.: 15/049,107

(22) Filed: Feb. 21, 2016

Related U.S. Application Data
(60) Provisional application No. 62/119,163, filed on Feb. 21, 2015.

(51) Int. Cl. C09D 9/04; C11D 3/39; C08J 11/06; C11D 3/04

(52) U.S. Cl. CPC C09D 9/04; C11D 3/044; C11D 3/39; C08J 11/06; C08J 2323/12

(57) ABSTRACT

Compositions, process mixtures, and kits are provided for removing one or more coatings from a polymeric film using a single-phase aqueous solution. The single-phase aqueous solution may include water; an inorganic base composition; a stable peroxygen composition; and a surfactant composition.

### CROSS-REFERENCE TO RELATED APPLICATIONS

This application claims priority to U.S. Provisional Patent Application No. 62/119,163, filed on Feb. 21, 2015, which is incorporated by reference herein in its entirety.

### BACKGROUND

Polymeric films, such as plastic regrind formed in recycling processes, may include undesirable coatings. For example, coatings may include inks, labels, adhesives, metallic films, and the like, e.g., on food packaging. It is desirable to process such polymeric films to remove undesired coatings prior to further uses of the films, such as recycled feedstocks for remanufactured plastics. Existing processes use extremely caustic solutions, high temperatures and/or pressures, or costly reagents to remove coatings.

The present application appreciates that removing coatings from polymeric films may be a challenging endeavor.

### SUMMARY

In one embodiment, a single-phase aqueous solution is provided. The single-phase aqueous solution may be used for removing one or more coatings from a polymeric film. The single-phase aqueous solution may include water. The single-phase aqueous solution may include an inorganic base composition. The single-phase aqueous solution may include a surfactant composition.

In another embodiment, a process mixture is provided. The process mixture may include a polymeric film. The polymeric film may include one or more coatings. The process mixture may include a single-phase aqueous solution. The single-phase aqueous solution may include water. The single-phase aqueous solution may include an inorganic base composition. The single-phase aqueous solution may include a surfactant composition.

In one embodiment, a method is provided for removing one or more coatings from a polymeric film using a single-phase aqueous solution. The method may include providing a single phase aqueous solution. The single phase aqueous solution may include water; an inorganic base composition; and a surfactant composition. The method may include providing a polymeric film. The polymeric film may include one or more coatings. The method may include contacting the single phase aqueous solution and the polymeric film to form a process mixture under conditions effective to remove a portion of the one or more coatings from the polymeric film.

In another embodiment, a kit is provided. The kit may be for making a single-phase aqueous solution for removing one or more coatings from a polymeric film. The kit may include one or more of: an inorganic base composition and a surfactant composition. The kit may include instructions. The instructions may direct a user to combine the inorganic base composition and the surfactant composition with water to form the single-phase aqueous solution.

### BRIEF DESCRIPTION OF THE DRAWINGS

The accompanying figures, which are incorporated in and constitute a part of the specification, illustrate example methods and apparatuses, and are used merely to illustrate example embodiments.

FIG. 1 is a flow diagram describing an example method.

FIG. 2 is a block diagram of an example kit.

### DETAILED DESCRIPTION

The present application relates to compositions, process mixtures, and kits for removing one or more coatings from a polymeric film, e.g., from food packaging.

In various embodiments, a single-phase aqueous solution is provided. The single-phase aqueous solution may be used for removing one or more coatings from a polymeric film. The single-phase aqueous solution may include an inorganic base composition. The single-phase aqueous solution may include a surfactant composition.

Various embodiments herein may recite the term “including,” or, in the claims, the term “comprising,” and their grammatical variants. For each such embodiment, corresponding additional embodiments are explicitly contemplated where the term “comprising” is replaced with “consisting essentially of” and “consisting of.” For example, the single-phase aqueous solution may consist essentially of: the water; the inorganic base composition; and the surfactant composition. In the single-phase aqueous solution consisting essentially of: the water; the inorganic base composition; and the surfactant composition, it is understood that the single-phase aqueous solution may, in some embodiments, include components of commercially available surfactant compositions described herein, for example, amounts of water or organic solvents such as alcohol. Further, for example, the single-phase aqueous solution may consist of: the water; the inorganic base composition; the stable peroxygen composition; and the surfactant composition.

In some embodiments, the inorganic base composition may include one or more of: an alkali metal hydroxide, an alkaline earth metal oxide, and an alkaline earth metal hydroxide. Further, the inorganic base composition may consist of, or may consist essentially of, one or more of: the alkali metal hydroxide, the alkaline earth metal oxide, or the alkaline earth metal hydroxide. As used herein, alkali metals may include, for example, lithium, sodium, potassium, rubidium, or cesium. Alkaline earth metals may include, for example, beryllium, magnesium, calcium, strontium, or barium. For example, the inorganic base composition may include one or more of: lithium hydroxide, sodium hydroxide, potassium hydroxide, magnesium oxide, calcium oxide, magnesium hydroxide, and calcium hydroxide. The inorganic base composition may consist of, or may consist essentially of, one or more of: lithium hydroxide, sodium hydroxide, potassium hydroxide, magnesium oxide, calcium oxide, magnesium hydroxide, or calcium hydroxide. The inorganic base composition may include sodium hydroxide. The inorganic base composition may consist of, or may consist essentially of, sodium hydroxide. The inorganic base composition may be present in an amount effective to establish a hydroxide concentration in moles/liter (M) in the single-phase aqueous solution of about one or more of: 0.0125 M to 0.5 M; 0.025 M to 0.4 M; 0.05 M to 0.3 M; 0.1 M to 0.2 M; 0.1 M to 0.15 M; and 0.125 M. The inorganic base composition may include sodium hydroxide, for example, sodium hydroxide in a weight percent concentration (w/w) with respect to the water in the single-phase aqueous solution of about 0.5%. The inorganic base composition may be provided as a solid or as a mixture or solution in water, for example, 50% aqueous sodium hydroxide.

In various embodiments, the surfactant composition may include a de-foaming agent. For example, the surfactant composition may include a polyether polyol de-foaming agent. Suitable polyether polyol de-foaming agents may be commercially available, e.g., the TERGITOL™ series of de-foaming agents, such as TERGITOL™ L64 (DOW Chemical Company, Midland, Mich.). The surfactant composition may include a de-foaming agent including one or more of: a carboxylic ester and a polyol ester. Suitable de-foaming agent combinations of one or more of a carboxylic ester and a polyol ester may be commercially available, e.g., the TRAMFLOC® series of de-foaming agents, e.g., TRAMFLOC® 1159 (Tramfloc, Inc, Tempe, Ariz.). The surfactant composition may include an alkyl polyalkylene glycol ether de-foaming agent. Suitable alkyl polyalkylene glycol ether de-foaming agents may be commercially available, e.g., the DEHYDEM® series of de-foaming agents, e.g., DEHYDEM® SUPRA (BASF Corporation, Florham Park, N.J.). It is to be understood that the use of such commercial de-foaming agents may add an organic solvent, such as an alcohol to the single phase aqueous solution. For example, TRAMFLOC® 1159 may include about 1-5% methanol. The surfactant composition may include a de-foaming agent including one or more of: a polyether polyol, an alkyl polyalkylene glycol ether, a carboxylic ester, and a polyol ester.

The surfactant composition may be present in a weight percentage (w/w) with respect to the water in the single-phase aqueous solution of one or more of about: 0.001% to 0.5%; 0.005% to 0.5%; 0.005% to 0.25%; 0.005% to 0.1%; 0.01% to 0.1%; 0.015% to 0.1%; 0.015% to 0.05%; 0.015% to 0.04%; and 0.02%.

In various embodiments, the single-phase aqueous solution of claim may be characterized by a pH value of about one or more of: 10 to 14; 10.5 to 14; 11 to 14; 11.5 to 14; 12 to 14; and 12.5 to 13.5. The single-phase aqueous solution may include the water in a weight percent concentration (w/w) of the single-phase aqueous solution of at least about one or more of: 98%, 99%, 99.1%, 99.2%, 99.25%, 99.3%, 99.4%, 99.5%, 99.6%, 99.7%, 99.8% and 99.9%. Further, for example, the single-phase aqueous solution may consist, or consisting essentially of: the inorganic base composition; the surfactant composition; and the water, the water being in a weight percent concentration (w/w) of the single-phase aqueous solution of at least about one or more of: 98%, 99%, 99.1%, 99.2%, 99.25%, 99.3%, 99.4%, 99.5%, 99.6%, 99.7%, 99.8% and 99.9%.

In various embodiments a process mixture is provided. The process mixture may include a polymeric film. The polymeric film may include one or more coatings. The process mixture may include a single-phase aqueous solution. The single-phase aqueous solution may include water. The single-phase aqueous solution may include an inorganic base composition. The single-phase aqueous solution may include a surfactant composition. The process mixture may consist essentially of, or may consist of, the polymeric film and the single-phase aqueous solution.

In some embodiments, the polymeric film may include one or more of: polyethylene, polyethylene terephthalate, polypropylene, polystyrene, and polycarbonate. The polymeric film may be in pieces or particulates, for example, as pieces of film, e.g., cut, shredded, or ground as part of a recycling process. The polymeric film, e.g., film, may be in pieces or particles and may be one or more of: recycled; virgin plastic; flexible, e.g., a film or a multi-layered film; fibrous; mixtures thereof; and the like. The polymeric film may include a single or multilayered film. The polymeric film may include a biaxially oriented multilayered film. The polymeric film may include a biaxially oriented polypropylene multilayered film. The polymeric film may include a food packaging film.

In several embodiments, the one or more coatings may include, for example, one or more of: a paint, an ink, a dye, a powder coat, a paper label, a plastic label, an adhesive, a barrier coating, a metalized coating, a food product, or a bio-coating. The bio-coating may be, for example, protein-based, oligo-saccharide based, and the like. The metalized coating may include a continuous film or metal particulates.

In various embodiments, the process mixture may include the water in a weight ratio to the polymeric film of one or more of about: 45:1 to 50:1; 10:1 to 40:1; 20:1 to 30:1; and 25:1.

In various embodiments, the single-phase aqueous solution may include any of the features or values for the single-phase aqueous solution as described herein.

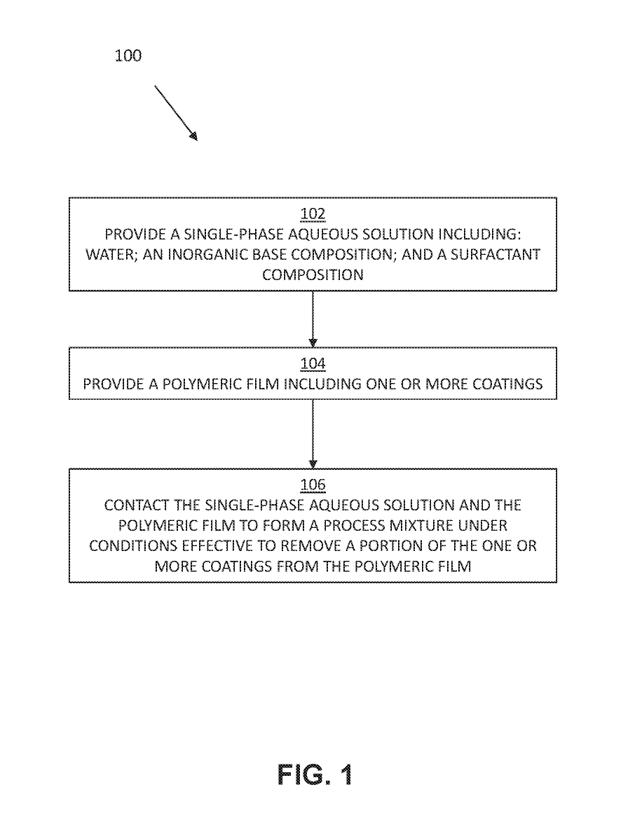

In various embodiments, a method 100 is provided for removing one or more coatings from a polymeric film using a single-phase aqueous solution. FIG. 1 depicts a flow chart of method 100. The method may include 102 providing a single phase aqueous solution. The single phase aqueous solution may include water. The single phase aqueous solution may include an inorganic base composition, for example, the inorganic base composition described herein. The single phase aqueous solution may include a surfactant composition. The method may include 104 providing a polymeric film, the polymeric film including one or more coatings. The method may include 106 contacting the single phase aqueous solution and the polymeric film to form a process mixture under conditions effective to remove a portion of the one or more coatings from the polymeric film.

In various embodiments, the conditions effective to remove a portion of the one or more coatings from the polymeric film may include heating the process mixture. The process mixture may be heated may be heated at a temperature of: between about 50° C. and about 100° C.; between about 60° C. and about 100° C.; 65° C. and about 100° C.; between about 70° C. and about 100° C.; between about 75° C. and about 95° C.; between about 80° C. and about 90° C.; about 85° C.; or between about any two of the preceding values, or about any of the preceding values, for example, between about 60° C. and about 100° C. or about 85° C.

In various embodiments, the conditions effective to remove a portion of the one or more coatings from the polymeric film may include: determining an initial coating amount; heating and agitating the process mixture; determining a process coating amount that is less than about a percentage of the initial coating amount; and recovering the polymeric film upon determining the process coating amount is less than about the percentage of the initial coating amount, the percentage of the initial coating amount being one or more of about: 20%, 15%, 14%, 13%, 12%, 11%, 10%, 9%, 8%, 7%, 6%, 5%, 4%, 3%, 2%, or 1%.

In various embodiments, the conditions effective to remove a portion of the one or more coatings from the polymeric film may include agitating the process mixture.

In various embodiments, the method may further include recovering the polymeric film after removal of the portion of the one or more coatings. The method may further include recovering at least a portion of the single phase aqueous solution after removal of the portion of the one or more coatings.

In various embodiments, the conditions effective to remove a portion of the one or more coatings from the polymeric film may include batch operation. The conditions effective to remove a portion of the one or more coatings may include continuous operation.

In several embodiments, the polymeric film may include a multilayered film, and the method may include separating at least a portion of layers of the multilayered film. The polymeric film may include a biaxially oriented multilayered film, and the method may include separating at least a portion of layers of the biaxially oriented multilayered film.

In some embodiments, the method may include combining the water in a weight ratio to the polymeric film of one or more of about: 5:1 to 50:1; 10:1 to 40:1; 20:1 to 30:1; and 25:1. The method may include forming the single-phase aqueous solution by stepwise addition to the water of: the inorganic base composition and the surfactant composition.

In various embodiments, the method may include providing the single-phase aqueous solution according to any of the features or values for the single-phase aqueous solution as described herein. The method may include preparing the single-phase aqueous solution according to any of the features or values for the single-phase aqueous solution as described herein. The method may include providing the process mixture according to any of the features or values for the process mixture as described herein. The method may include preparing the process mixture according to any of the features or values for the process mixture as described herein.

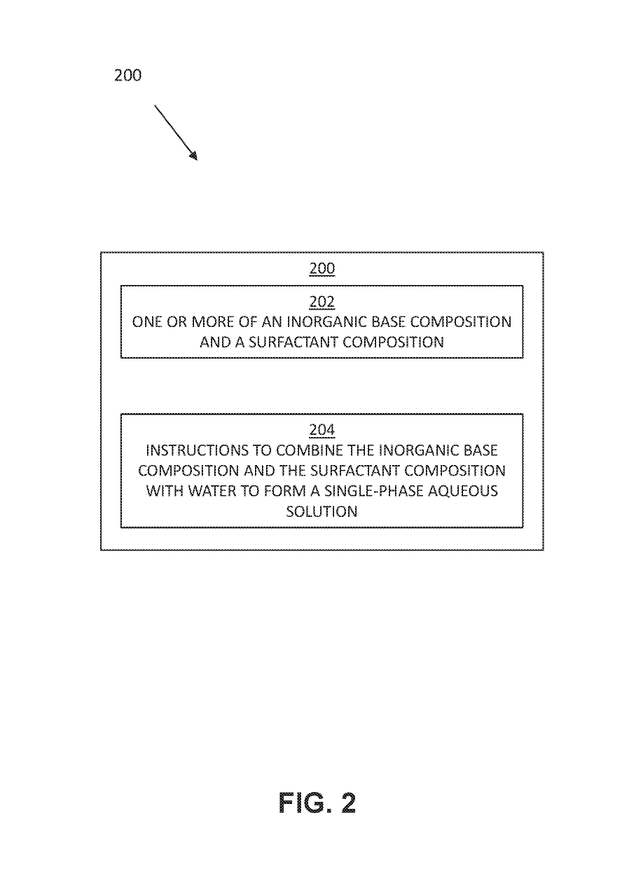

In various embodiments, a kit 200 is provided. FIG. 2 depicts a block diagram of kit 200. Kit 200 may be for making a single-phase aqueous solution for removing one or more coatings from a polymeric film. The kit may include 202 one or more of: an inorganic base composition and a surfactant composition. The kit may include instructions 204. The instructions may direct a user to combine the inorganic base composition and the surfactant composition with water to form the single-phase aqueous solution.

In some embodiments, the kit may include the inorganic base composition and the surfactant composition. The kit may include at least one of the inorganic base composition and the surfactant composition as a dry composition or a neat composition. The kit may include a mixture of the inorganic base composition and the surfactant composition together with water in the form of an aqueous concentrate.

In several embodiments, the instructions may direct the user to form a process mixture by contacting the single-phase aqueous solution to the polymeric film including the one or more coatings. The instructions may include directing the user to provide the single-phase aqueous solution according to any of the features or values for the single-phase aqueous solution as described herein. The instructions may include directing the user to prepare the single-phase aqueous solution according to any of the features or values for the single-phase aqueous solution as described herein. The instructions may include directing the user to provide the process mixture according to any of the features or values for the process mixture as described herein. The instructions may include directing the user to prepare the process mixture according to any of the features or values for the process mixture as described herein. The instructions may include directing the user to conduct the method according to any of the features or values for the method as described herein.

### EXAMPLE

Approximately 50 lbs. of hot water, heated to about 85° C., was added to a mixing tank. A multilayered, biaxially oriented polypropylene (BOPP) film derived from snack food bags was obtained, which included metallic and ink coatings. Approximately 2 lbs. of the BOPP film, in pieces of approximately 0.375 inch mesh size, was added to the water gravimetrically with mixing to create a slurry. The level of initial ink contaminants, base resin and back coat, was determined. To the slurry was added 0.5% (w/w) sodium hydroxide. The slurry foamed greatly. A commercial, alcohol-based de-foaming surfactant agent (TRAMFLOC® 1159, Tramfloc, Inc, Tempe, Ariz.) was added drop-wise (5 drops) until the foam subsided, resulting in approximately 0.002 (% w/w) of de-foaming surfactant based upon water content. Beginning at 2 h, samples were taken every 30 min until the film was considered acceptably free from the coating. At approximately 3 h, the film was determined to be 98% clean. At approximately 4 h, the film was determined to be 99%+clean. The reaction mixture was poured over a filter to remove the aqueous phase and the product was rinsed with water and dried. The aqueous phase was recoverable for re-use and/or recovery of the reagents. This example shows that the described composition and method removes the coatings from the BOPP film using minimal solvents and tends to prevent re-attachment of the coating dyes to the substrate. The described composition and method also delaminates and separates the multiple layers of the BOPP film. In this example, the BOPP film was separated into two clear layers and one green layer.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the terms “operatively coupled” or “operatively connected” are used in the specification or the claims, it is intended to mean that the identified components are connected in a way to perform a designated function. To the extent that the term “substantially” is used in the specification or the claims, it is intended to mean that the identified components have the relation or qualities indicated with degree of error as would be acceptable in the subject industry.

As used in the specification and the claims, the singular forms “a,” “an,” and “the” include the plural unless the singular is expressly specified. For example, reference to “a compound” may include a mixture of two or more compounds, as well as a single compound.

As used herein, the term “about” in conjunction with a number is intended to include ±10% of the number. In other words, “about 10” may mean from 9 to 11.

As used herein, the terms “optional” and “optionally” mean that the subsequently described circumstance may or may not occur, so that the description includes instances where the circumstance occurs and instances where it does not.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

As used herein, “substituted” refers to an organic group as defined below (e.g., an alkyl group) in which one or more bonds to a hydrogen atom contained therein may be replaced by a bond to non-hydrogen or non-carbon atoms. Substituted groups also include groups in which one or more bonds to a carbon(s) or hydrogen(s) atom may be replaced by one or more bonds, including double or triple bonds, to a heteroatom. A substituted group may be substituted with one or more substituents, unless otherwise specified. In some embodiments, a substituted group may be substituted with 1, 2, 3, 4, 5, or 6 substituents. Examples of substituent groups include: halogens (i.e., F, Cl, Br, and I); hydroxyls; alkoxy, alkenoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; or nitriles (i.e., CN). A “per”-substituted compound or group is a compound or group having all or substantially all substitutable positions substituted with the indicated substituent. For example, 1,6-diiodo perfluoro hexane indicates a compound of formula C₆F₁₂I₂, where all the substitutable hydrogens have been replaced with fluorine atoms.

Substituted ring groups such as substituted cycloalkyl, aryl, heterocyclyl and heteroaryl groups also include rings and ring systems in which a bond to a hydrogen atom may be replaced with a bond to a carbon atom. Substituted cycloalkyl, aryl, heterocyclyl and heteroaryl groups may also be substituted with substituted or unsubstituted alkyl, alkenyl, and alkynyl groups as defined below.

Alkyl groups include straight chain and branched chain alkyl groups having from 1 to 12 carbon atoms, and typically from 1 to 10 carbons or, in some examples, from 1 to 8, 1 to 6, or 1 to 4 carbon atoms. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above and include, without limitation, haloalkyl (e.g., trifluoromethyl), hydroxyalkyl, thioalkyl, aminoalkyl, alkylaminoalkyl, dialkylaminoalkyl, alkoxyalkyl, or carboxyalkyl.

Cycloalkyl groups include mono-, bi- or tricyclic alkyl groups having from 3 to 12 carbon atoms in the ring(s), or, in some embodiments, 3 to 10, 3 to 8, or 3 to 4, 5, or 6 carbon atoms. Exemplary monocyclic cycloalkyl groups include, but are not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments, the number of ring carbon atoms ranges from 3 to 5, 3 to 6, or 3 to 7. Bi- and tricyclic ring systems include both bridged cycloalkyl groups and fused rings, such as, but not limited to, bicyclo[2.1.1]hexane, adamantyl, or decalinyl. Substituted cycloalkyl groups may be substituted one or more times with non-hydrogen and non-carbon groups as defined above. However, substituted cycloalkyl groups also include rings that may be substituted with straight or branched chain alkyl groups as defined above. Representative substituted cycloalkyl groups may be mono-substituted or substituted more than once, such as, but not limited to, 2,2-, 2,3-, 2,4- 2,5- or 2,6-disubstituted cyclohexyl groups, which may be substituted with substituents such as those listed above.

Aryl groups may be cyclic aromatic hydrocarbons that do not contain heteroatoms. Aryl groups herein include monocyclic, bicyclic and tricyclic ring systems. Aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. In some embodiments, the aryl groups may be phenyl or naphthyl. Although the phrase “aryl groups” may include groups containing fused rings, such as fused aromatic-aliphatic ring systems (e.g., indanyl or tetrahydronaphthyl), “aryl groups” does not include aryl groups that have other groups, such as alkyl or halo groups, bonded to one of the ring members. Rather, groups such as tolyl may be referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl, which may be substituted with substituents such as those above.

Aralkyl groups may be alkyl groups as defined above in which a hydrogen or carbon bond of an alkyl group may be replaced with a bond to an aryl group as defined above. In some embodiments, aralkyl groups contain 7 to 16 carbon atoms, 7 to 14 carbon atoms, or 7 to 10 carbon atoms. Substituted aralkyl groups may be substituted at the alkyl, the aryl or both the alkyl and aryl portions of the group. Representative aralkyl groups include but are not limited to benzyl and phenethyl groups and fused (cycloalkylaryl)alkyl groups such as 4-indanylethyl. Substituted aralkyls may be substituted one or more times with substituents as listed above.

Groups described herein having two or more points of attachment (i.e., divalent, trivalent, or polyvalent) within the compound of the technology may be designated by use of the suffix, “ene.” For example, divalent alkyl groups may be alkylene groups, divalent aryl groups may be arylene groups, divalent heteroaryl groups may be heteroarylene groups, and so forth. In particular, certain polymers may be described by use of the suffix “ene” in conjunction with a term describing the polymer repeat unit.

Alkoxy groups may be hydroxyl groups (—OH) in which the bond to the hydrogen atom may be replaced by a bond to a carbon atom of a substituted or unsubstituted alkyl group as defined above. Examples of linear alkoxy groups include, but are not limited to, methoxy, ethoxy, propoxy, butoxy, pentoxy, or hexoxy. Examples of branched alkoxy groups include, but are not limited to, isopropoxy, sec-butoxy, tert-butoxy, isopentoxy, or isohexoxy. Examples of cycloalkoxy groups include, but are not limited to, cyclopropyloxy, cyclobutyloxy, cyclopentyloxy, or cyclohexyloxy. Representative substituted alkoxy groups may be substituted one or more times with substituents such as those listed above.

The various aspects and embodiments disclosed herein are for purposes of illustration and are not intended to be limiting, with the true scope and spirit being indicated by the following claims.

1. A single-phase aqueous solution for removing one or more coatings from a polymeric film, comprising:
water;
an inorganic base composition;
a stable peroxygen composition; and
a surfactant composition.

2. The single-phase aqueous solution of claim 1, the inorganic base composition comprising one or more of: an alkali metal hydroxide, an alkaline earth metal oxide, an alkaline earth metal hydroxide.

3. The single-phase aqueous solution of claim 1, the inorganic base composition comprising one or more of: lithium hydroxide, sodium hydroxide, potassium hydroxide, magnesium oxide, calcium oxide, magnesium hydroxide, and calcium hydroxide.

4. The single-phase aqueous solution of claim 1, the inorganic base composition being present in an amount effective to establish a hydroxide concentration in moles/liter (M) of about one or more of: 0.0125 M to 0.5 M; 0.025 M to 0.4 M; 0.05 M to 0.3 M; 0.1 M to 0.2 M; 0.1 M to 0.15 M; and 0.125 M.

5. The single-phase aqueous solution of claim 1, the inorganic base composition comprising sodium hydroxide.

6. The single-phase aqueous solution of claim 1, the inorganic base composition comprising sodium hydroxide in a weight percent concentration (w/w) with respect to the water of about 0.5%.

7. The single-phase aqueous solution of claim 1, the surfactant composition comprising a de-foaming agent comprising one or more of: a polyether polyol, an alkyl polyalkylene glycol ether, a carboxylic ester, and a polyol ester.

8. The single-phase aqueous solution of claim 1, characterized by one or more of:
the surfactant composition being present in a weight percentage (w/w) with respect to the water of one or more of about: 0.005% to 0.5%; 0.005% to 0.5%; 0.005% to 0.25%; 0.005% to 0.1%; 0.01% to 0.1%; 0.015% to 0.1%; 0.015% to 0.05%; 0.015% to 0.04%; and 0.02%;
a pH value of about one or more of: 10 to 14; 10.5 to 14; 11 to 14; 11.5 to 14; 12 to 14; and 12.5 to 13.5; and
the water in a weight percent concentration (w/w) of the single-phase aqueous solution of at least about one or more of: 98%, 99%, 99.1%, 99.2%, 99.25%, 99.3%, 99.4%, 99.5%, 99.6%, 99.7%, 99.8% and 99.9%.

9. The single-phase aqueous solution of claim 1, consisting essentially of: the inorganic base composition, the surfactant composition; and the water, the water being in a weight percent concentration (w/w) of the single-phase aqueous solution of at least about one or more of: 98%, 99%, 99.1%, 99.2%, 99.25%, 99.3%, 99.4%, 99.5%, 99.6%, 99.7%, 99.8% and 99.9%.

10. A method 100 for removing one or more coatings from a polymeric film using a single-phase aqueous solution, comprising:
102 providing a single phase aqueous solution comprising: water; an inorganic base composition; and a surfactant composition;
104 providing a polymeric film, the polymeric film comprising one or more coatings; and
106 contacting the single phase aqueous solution and the polymeric film to form a process mixture under conditions effective to remove a portion of the one or more coatings from the polymeric film.

11. The method of claim 10, the conditions effective to remove a portion of the one or more coatings from the polymeric film comprising heating and/or agitating the process mixture.

12. The method of claim 10, the conditions effective to remove a portion of the one or more coatings from the polymeric film comprising heating the process mixture at a temperature of about one or more of: 50° C. to 100° C.; 60° C. to 100° C.; 65° C. to 100° C.; 70° C. to 100° C.; 75° C. to 95° C.; 80° C. to 90° C.; and 85° C.

13. The method of claim 10, the conditions effective to remove a portion of the one or more coatings from the polymeric film comprising: determining an initial coating amount; heating and agitating the process mixture; determining a process coating amount that is less than about a percentage of the initial coating amount; and recovering the polymeric film upon determining the process coating amount is less than about the percentage of the initial coating amount, the percentage of the initial coating amount being one or more of about: 20%, 15%, 14%, 13%, 12%, 11%, 10%, 9%, 8%, 7%, 6%, 5%, 4%, 3%, 2%, and 1%.

14. The method of claim 10, further comprising recovering the polymeric film after removal of the portion of the one or more coatings.

15. The method of claim 10, further comprising recovering at least a portion of the single phase aqueous solution after removal of the portion of the one or more coatings.

16. The method of claim 10, comprising removing a portion of the one or more coatings from the polymeric film by an operation comprising one or more of: batch operation and continuous operation.

17. The method of claim 10, the polymeric film comprising a multilayered film, further comprising separating at least a portion of layers of the multilayered film.

18. The method of claim 10, the polymeric film comprising a biaxially oriented multilayered film, further comprising separating at least a portion of layers of the biaxially oriented multilayered film.

19. The method of claim 10, comprising combining the water in a weight ratio to the polymeric film of one or more of about: 5:1 to 50:1; 10:1 to 40:1; 20:1 to 30:1; and 25:1.

20. The method of claim 10, further comprising forming the single-phase aqueous solution by stepwise addition to the water of: the inorganic base composition and the surfactant composition.
